(19) United States
(12) Patent Application Publication
(10) Pub. No.: US 2003/0058265 A1
(43) Pub. Date: Mar. 27, 2003

(54) System and method for providing tactility for an LCD touchscreen

(76) Inventors: James A. Robinson, Elmira (CA); Robert J. Lowles, Waterloo (CA); Bryan Taylor, Waterloo (CA)

Correspondence Address: David B. Cochran, Esq., Jones, Day, Reavis & Pogue, North Point, 901 Lakeside Ave, Cleveland, OH, 44114, US

(21) Appl. No.: 10/228,611

(22) Filed: Aug. 27, 2002

Related U.S. Application Data
(60) Provisional application No. 60/315,556, filed on Aug. 28, 2001.

(51) Int. Cl. G09G 5/00

(52) U.S. Cl. 345/701

(57) ABSTRACT

A system for providing force feedback in response to touchscreen inputs by a user is disclosed. A touchscreen overlayed upon a liquid crystal display (LCD) receives user input and provides a corresponding signal to a controller or CPU. The CPU then activates an actuator for physically vibrating or pulsing the electronic device in which the touchscreen and LCD are contained. The physical movement of the electronic device provides tactile feedback to the user for indicating that an input to the touchscreen has been made. The actuator can include a vibrating motor, solenoid and other mechanical means for providing various types of physical movement.

### RELATED APPLICATION

This application claims priority on U.S. provisional application Serial No. 60/315,556 entitled SYSTEM AND METHOD FOR PROVIDING TACTILITY FOR AN LCD TOUCHSCREEN filed Aug. 28, 2001. By this reference, the full disclosure, including the drawings, of U.S. provisional application Serial No. 60/315,556 is incorporated herein.

### FIELD OF THE INVENTION

The present invention generally relates to interfaces between users and computing devices. More particularly, the present invention relates to liquid crystal display interfaces.

### BACKGROUND OF THE INVENTION

Buttons, track balls and thumbwheels are well known user interfaces that permit users to operate electronic devices. In devices where space is limited, such as in mobile communication devices and personal digital assistants (PDA), touchscreens are preferred as the user interface since their virtual “buttons” do not require the assemblies and space required for implementing mechanical user interfaces such as buttons, track balls and thumbwheels.

Although touchscreens have been commonly used for electronic devices, they do not offer the tactility of the aforementioned mechanical user interfaces. For example, the user can physically feel that an input has been made because the buttons or wheels move. Touchscreens on the other hand do not have perceptible movement when the user touches it with a finger or stylus. Therefore, the user can only visually confirm that an input has been made. Visual-only feedback substantially increases the possibility of input error, which decreases the efficiency of use. Audio notification is commonly used in electronic devices, but does not work well in noisy environments and can disturb the user or other people who are close by.

It is, therefore, desirable to provide a means for reliably alerting the user that a touchscreen input has been made.

### SUMMARY OF THE INVENTION

It is an object of the present invention to obviate or mitigate at least one disadvantage of previous touchscreen and LCD user interface feedback systems. In particular, it is an object of the present invention to provide a touchscreen and LCD user interface that reliably validates an input made by the user through the touchscreen.

In a first aspect, the present invention provides a force feedback system having a touchscreen controller for providing touchscreen data in response to a touchscreen contact, and a liquid crystal display for displaying graphics. The force feedback system includes a controller for determining display data and actuator control signals in response to the touchscreen data, where the liquid crystal display displaying the graphics corresponding to the display data, and an actuator for pulsing in response to the actuator control signals.

In an embodiment of the present aspect, the controller, and the touchscreen controller are integrated within a single application specific integrated circuit.

In further embodiments of the present aspect, the actuator includes multiple actuating devices, and the actuator can include a vibrating motor or a solenoid.

In further aspect, the present invention provides a method for tactile notification in a system having a touchscreen and liquid crystal display user interface. The method includes the steps of prompting for an input through the liquid crystal display, providing actuator control signals when the touchscreen is touched, and activating an actuator for providing force feedback in response to the actuator control signals.

In an embodiment of the present aspect, the step of prompting includes driving the liquid crystal display with graphical information for requesting the input.

In another embodiment of the present aspect, the step of providing actuator control signals includes receiving electrical signals from the touchscreen when the touchscreen is touched, decoding the electrical signals into touchscreen data, and processing the touchscreen data to generate the actuator control signals.

In yet another embodiment of the present aspect, the step of providing actuator control signals includes providing display data when the touchscreen is touched, and the step of providing display data includes receiving electrical signals from the touchscreen when the touchscreen is touched, decoding the electrical signals into touchscreen data, and processing the touchscreen data to generate display data.

In yet a further embodiment of the present aspect, the step of activating the actuator includes changing the graphics of the liquid crystal display in response to the display data, and the step of changing includes driving the liquid crystal display with graphical information requesting another input.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of a force feedback system for a touchscreen and LCD user interface according to an embodiment of the present invention; and

FIG. 2 is a flow diagram describing a method for providing tactile feedback in the system of FIG. 1.

### DETAILED DESCRIPTION

Generally, the present invention provides a method and system for providing force feedback in response to touchscreen inputs by a user. A touchscreen overlayed upon a liquid crystal display (LCD) receives user input and provides a corresponding signal to a controller or central processing unit (CPU). The CPU then activates the actuator for physically vibrating or pulsing the electronic device in which the touchscreen and LCD are contained. The physical movement of the electronic device provides tactile feedback to the user for indicating that an input to the touchscreen has been made. The actuator can include a vibrating motor, solenoid and other mechanical means for providing different types of physical movement.

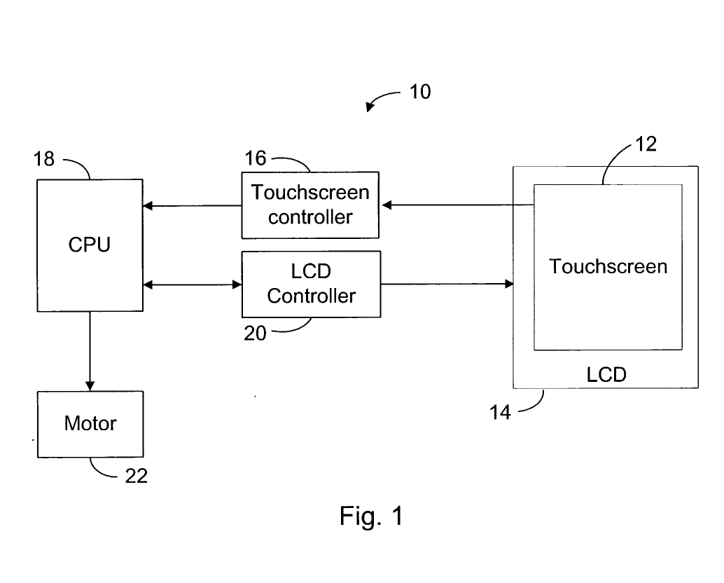

FIG. 1 is a block diagram for a force feedback system 10 with a touchscreen and LCD user interface according to an embodiment of the present invention. Examples of such electronic devices include PDA's, mobile communication devices such as cellular phones, and Blackberry™ communication devices. A force feedback system 10 includes a touchscreen 12, an LCD 14, a touchscreen controller 16, a controller such as CPU 18, an LCD controller 20 and an actuator 22. The touchscreen 12 is a transparent layer that is placed over LCD 14, and may be but are not limited to a resistive or a capacitive type. Resistive touchscreens use a thin membrane over the glass of an LCD so that when the membrane is touched, the touchscreen controller measures the resistance at the point of touch and computes the x-y coordinates. Capacitive touchscreens use a thin transparent conductive membrane over the surface of the glass on an LCD which forms an x-y grid of conductors. When the overlay is touched with a finger, capacitive coupling exists between the x and y conductors at the point of contact. The location of this coupling is measured by scanning the x and y conductors.

The touchscreen 12 provides electrical signals corresponding to the x-y coordinates at the location where the touchscreen has been touched. The touchscreen controller 16 decodes the electrical signal received from the touchscreen 12, and provides touchscreen data to the CPU 18. The CPU 18 provides display data to the LCD controller 20, which drives the LCD 14 to display graphical information such as text or graphical buttons enclosing text, for example. The actuator 22 is controlled by the CPU 18 via actuator control signals for providing force feedback to the user. Preferably, the actuator comprises a vibrating motor. Motors for vibrating are well known in the art, and therefore do not require further discussion.

The operation of the tactile feedback electronic device 10 of FIG. 1 is now described. When the user makes contact with the touchscreen 12, the touchscreen controller 16 sends touchscreen data corresponding to the electrical signals received from the touchscreen to the CPU 18. The CPU 18 then generates actuator control signals to activate, or turn on, the actuator 22 for a predetermined amount of time within the device in order to generate a tactile response that reflects what the user is doing on the screen. For example, if the user pressed on a button as it appeared on the LCD 14, the response may feel like a click. Another possible input example would be the user sliding a finger along a scrolling bar on the LCD 14, for which the response might be a vibration that diminishes or increases in intensity as the user slides a finger along the bar. The tactile responses that can be generated are numerous and are not limited to the previous two examples. The CPU 18 will also send display data to the LCD controller 20, which controls the necessary graphical changes to the LCD 14 to visually confirm the user's input, or to request additional input from the user.

It should be apparent to those skilled in the art that the motor 22 in FIG. 1 is an illustrative example of a possible actuator for providing force feedback. Other actuators configured to produce tactile, or force, feedback in response to user inputs will be obvious and thus within the scope of the present invention. The particular actuators implemented in the device may depend on the available physical space on or within the device, the types of feedback to be provided, or perhaps the presence of other actuators for other purposes such as notifying a user of an appointment, receipt of a new message and the like. It is also contemplated that multiple actuating devices may be implemented in any device. For example, each actuating device can vibrate the electronic device in different directions and in different combinations to provide tactile information. While a vibrating motor can be used to provide tactile feedback in the system of FIG. 1, a solenoid can be implemented in the same device to provide a mechanical pulse, or “click” feedback when a user presses a button on the touchscreen.

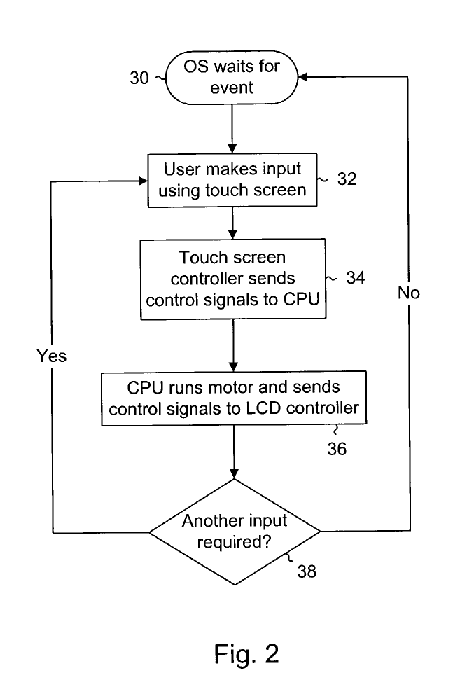

FIG. 2 is a flow diagram describing a method for providing tactile feedback for the tactile feedback electronic device 10 of FIG. 1. The process begins in step 30, where the device operating system (OS) waits for an input event. This can be done by driving the LCD with display data to visually prompt the user to make an input, for example. In step 32, the user makes an input by touching the touchscreen 12. Electrical signals are received by the touchscreen controller 16 and decoded into touchscreen data representing the x-y coordinates of the area where the touchscreen was touched. The touchscreen controller 16 sends the touchscreen data to the CPU 18 at step 34. In step 36, the CPU 18 processes the touchscreen data and generates actuator control signals to turn on the actuator 22 and generate a tactile response to reflect the event (input) that was generated by the user. The CPU 18 then sends display data to the LCD controller 20 to change the graphical information displayed on the LCD 14 to reflect the event generated by the user. This graphical information is changed by driving the LCD with new display data. If the user is required to make another input, as determined at step 38, the user is prompted to do so via the information displayed on the LCD 14, and the process returns to step 32. If the user is not required to make another input, the process will return to step 20 and the device waits for another input event.

Therefore, the tactile feedback electronic device according to the embodiments of the present invention can improve the efficiency of use of the electronic device by physically validating touchscreen inputs to the user.

Although a CPU-based system is illustrated in the preferred embodiment of the present invention, specialized micro-controllers and other highly integrated controllers such as application specific integrated circuits (ASIC) can be used in place of the separate CPU, LCD controller and touchscreen controller implementation shown in FIG. 1. In other words, an ASIC device can integrate CPU functionality with the LCD and touchscreen controller functionality on a single chip. Such an alternate embodiment will occupy less board space in the device and allow more components to be placed within the device. In another alternate embodiment, the controller, or CPU 18 is pre-programmed with different types of vibrating modes. Hence the touchscreen data can be processed to generate the corresponding type of vibration. For example, the actuator can be pulsed or the duration of time the actuator is turned is varied based on the type of request and corresponding input that is made.

Similarly, the detection of a touchscreen input and activation of an actuator by a device CPU or operating system software is described above for illustrative purposes only. The invention is in no way limited to CPU-based detection of an input. A touchscreen controller, an LCD controller, or another device component or system can be configured to detect an input and provide a control output to one or more actuators.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A force feedback system having a touchscreen controller for providing touchscreen data in response to a touchscreen contact, and a liquid crystal display for displaying graphics, the system comprising:
a controller for determining display data and actuator control signals in response to the touchscreen data, the liquid crystal display displaying the graphics corresponding to the display data; and,
an actuator for pulsing in response to the actuator control signals.

2. The force feedback system of claim 1, wherein the controller and the touchscreen controller are integrated within a single application specific integrated circuit.

3. The force feedback system of claim 1, wherein the actuator includes multiple actuating devices.

4. The force feedback system of claim 1, wherein the actuator includes a vibrating motor.

5. The force feedback system of claim 1, wherein the actuator includes a solenoid.

6. A method for tactile notification in a system having a touchscreen and liquid crystal display user interface comprising:
(a) prompting for an input through the liquid crystal display;
(b) providing actuator control signals when the touchscreen is touched; and,
(c) activating an actuator for providing force feedback in response to the actuator control signals.

7. The method for tactile notification of claim 6, wherein the step of prompting includes driving the liquid crystal display with graphical information for requesting the input.

8. The method for tactile notification of claim 6, wherein the step of providing actuator control signals includes:
(i) receiving electrical signals from the touchscreen when the touchscreen is touched,
(ii) decoding the electrical signals into touchscreen data, and
(iii) processing the touchscreen data to generate the actuator control signals.

9. The method for tactile notification of claim 6, wherein the step of providing actuator control signals includes providing display data when the touchscreen is touched.

10. The method for tactile notification of claim 9, wherein the step of providing display data includes:
(i) receiving electrical signals from the touchscreen when the touchscreen is touched,
(ii) decoding the electrical signals into touchscreen data, and
(iii) processing the touchscreen data to generate display data.

11. The method for tactile notification of claim 9, wherein the step of activating the actuator includes changing the graphics of the liquid crystal display in response to the display data.

12. The method for tactile notification of claim 11, wherein the step of changing includes driving the liquid crystal display with graphical information requesting another input.
